(19) United States
(12) Patent Application Publication
(10) Pub. No.: US 2018/0140085 A1
(43) Pub. Date: May 24, 2018

(54) GRILL CLEANER INCLUDING WIRE LOOPS

(71) Applicant: Brookstone Purchasing, Inc., Merrimack, NH (US)

(72) Inventor: Stephen B. Mills, Atkinson, NH (US)

(21) Appl. No.: 15/816,854

(22) Filed: Nov. 17, 2017

Related U.S. Application Data
(60) Provisional application No. 62/424,155, filed on Nov. 18, 2016.

(51) Int. Cl. A46D 1/00; A46B 5/02; A46B 15/00; A47J 37/07; A46B 9/02

(52) U.S. Cl. CPC A46D 1/0253; A46B 5/02; A46B 15/0081; A46B 15/0063; A46B 2200/3073; A46D 1/0207; A46B 9/02; A46B 2200/3093; A47J 37/0786

(57) ABSTRACT

A grill cleaner generally includes a wire brush formed by a plurality of wire loops extending from a brush block. The wire loops may include a solid core wire or a wire cable/cord (e.g., a plurality of wound wire strands). In one embodiment, the wire loops may be formed as individual wire loops having the ends secured in sleeves (e.g., crimped). The grill cleaner also include one or more handles to allow a user to urge the wire loops across a grate of a grill such that movement of the wire loops across the grate dislodges debris (e.g., food particles) adhered to a surface of the grate.

### CROSS-REFERENCE TO RELATED APPLICATIONS

The present disclosure claims the benefit of U.S. Provisional Application Ser. No. 62/424,155 filed on Nov. 18, 2016, the entire disclosure of which is incorporated in its entirety herein by reference.

### TECHNICAL FIELD

The present disclosure is generally related to a grill cleaning apparatus and more specifically to a grill cleaning apparatus including a plurality of wire loops.

### BACKGROUND INFORMATION

Food preparation may include the heating and/or cooking of food items placed on one or more cooking grates. A heat source positioned beneath the grates may cook the one or more food items. The heat source may include one or more of, for example, an electric heating coil, fire (e.g., as generated by natural gas, propane, coal, charcoal, and the like), and/or any other suitable form of heating. As the food items cook, debris (e.g., oils and/or fats released from the food items) may adhere to multiple surfaces (e.g., top, bottom, and/or sides) of the cooking grates and soil one or more of the surfaces of the grates. The debris may be difficult to remove without the use of a scraper or brush. Conventional wire brushes including bundles or tufts of wire bristles may present a hazard when wire bristle segments separate from the brush and fall onto the grill grate. For example, one or more of the bristles may become lodged in a food product to be consumed by a user of the grill. Consumption of a wire bristle may be harmful a user's health.

### BRIEF DESCRIPTION OF THE DRAWINGS

These and other features and advantages will be better understood by reading the following detailed description, taken together with the drawings, wherein:

FIG. 1 shows a perspective exploded view of a grill cleaner, consistent with embodiments of the present disclosure.

FIG. 2 shows a perspective view of an example of a cable that may be used with the grill cleaner of FIG. 1, consistent with embodiments of the present disclosure.

FIG. 3 shows another perspective exploded view of the grill cleaner of FIG. 1, consistent with embodiments of the present disclosure.

FIG. 4 shows a cross-section of the grill cleaner of FIG. 1, consistent with embodiments of the present disclosure.

FIG. 5 shows a perspective view of the grill cleaner of FIG. 1 being used to clean a grill grate, consistent with embodiments of the present disclosure.

FIG. 6 shows another perspective view of the grill cleaner of FIG. 1 being used to clean a grill grate, consistent with embodiments of the present disclosure.

FIG. 7 shows a perspective view of a grill scraper that may be used with the grill cleaner of FIG. 1, consistent with embodiments of the present disclosure.

FIG. 8 shows a perspective view of an example of a grill cleaner, consistent with embodiments of the present disclosure.

FIG. 9 shows a plan view of the grill cleaner of FIG. 8, consistent with embodiments of the present disclosure.

FIG. 10 shows a perspective view of a brush block capable of being used with the grill cleaner of FIG. 8, consistent with embodiments of the present disclosure.

FIG. 11 shows a cross-sectional view of the brush block of FIG. 10, consistent with embodiments of the present disclosure.

FIG. 12 shows a plan view of a grill cleaner having a ball-shaped grip, consistent with embodiments of the present disclosure.

FIG. 13 shows a plan view of a grill cleaner having a T-shaped grip, consistent with embodiments of the present disclosure.

FIG. 14 shows a plan view of the grill cleaner of FIG. 13, consistent with embodiments of the present disclosure.

### DETAILED DESCRIPTION

A grill cleaner, consistent with embodiments of the present disclosure, generally includes a wire brush formed by a plurality of wire loops extending from a brush block. The wire loops may include a solid core wire or a wire cable/cord (e.g., a plurality of wound wire strands). In one embodiment, the wire loops may be formed as individual wire loops having the ends secured in sleeves (e.g., crimped). The grill cleaner also include one or more handles to allow a user to urge the wire loops across a grate of a grill such that movement of the wire loops across the grate dislodges debris (e.g., food particles) adhered to a surface of the grate. The wire loops flex just enough to clean off grill grates and are more resistant to damage than conventional bundles or tufts of wire bristles. In particular, the wire loops are less likely to separate from the brush block during use. As a result, the risk of wire pieces contaminating a food surface and/or food product may be reduced when compared to a grill cleaner utilizing bundles of wire bristles.

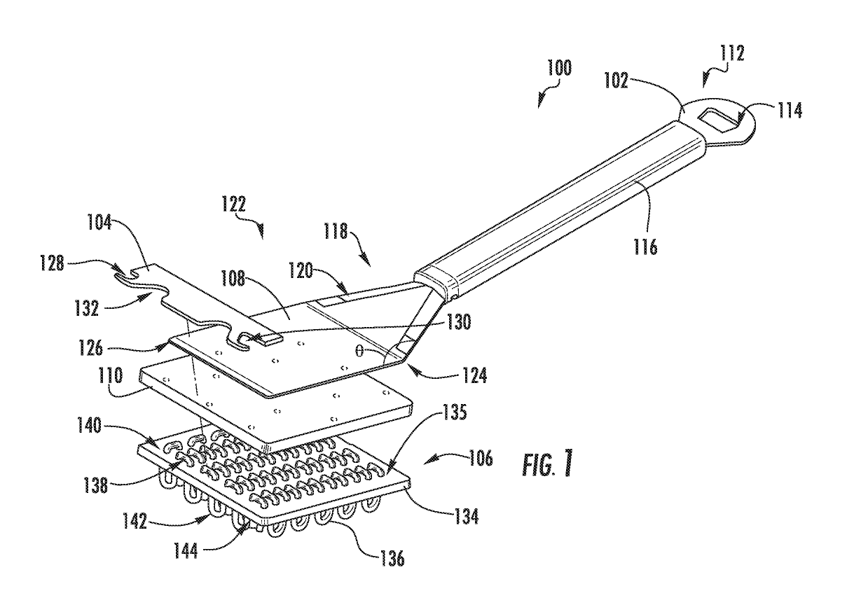

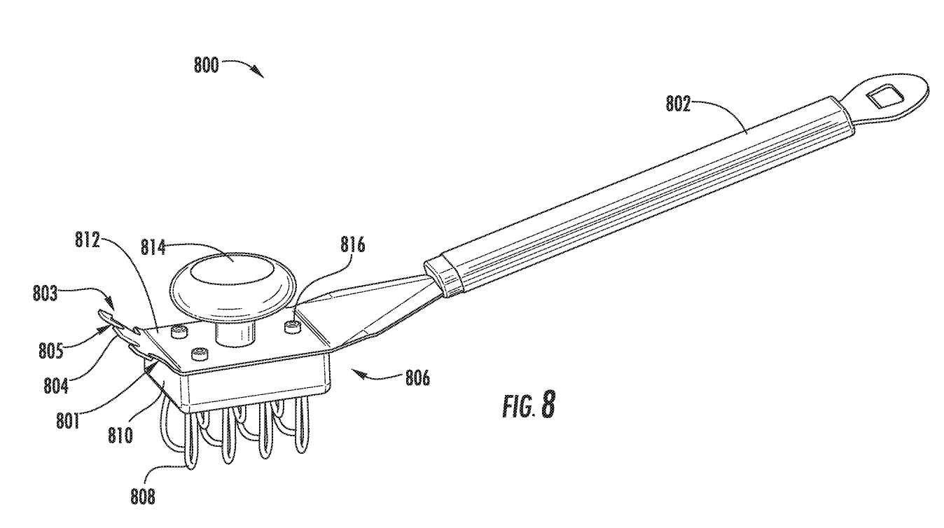

The wire loops, as discussed herein, may have any shape including, for example, a tear-drop shape, an elliptical shape, a semi-circular shape, a triangular shape, a square shape, a rectangular shape, a hexagonal shape, a piriform/pear-shape, and/or any other suitable shape. By way of further example, and as shown in FIGS. 1 and 8, the wire loops 142 and 808 may include an arcuate portion.

Referring to FIGS. 1-7, a grill cleaner 100, consistent with one embodiment of the present disclosure, is shown and described in greater detail. The grill cleaner 100 includes a handle 102 coupled to a grill scraper 104 and a wire brush 106. The handle 102 may include (and/or be coupled to) a platform 108. The platform 108 may be coupled to the grill scraper 104 and a connecting block 110. The connecting block 110 may be coupled to the wire brush 106.

As shown, a first distal end 112 of the handle 102 may include an opening (or aperture) 114 extending through the handle 102. The opening 114 may define a tool for removing, for example, one or more bottle caps from beverage bottles. As also shown, the handle 102 may also include a handle grip 116 at least partially circumscribing a portion of the handle 102. The handle grip 116 may be coupled to or formed from the handle 102. For example, in some instances, the handle grip 116 may be a molded plastic, wood, elastomer, metal, or any other suitable material capable of being coupled to the handle 102, in these instances, the handle grip 116 may be coupled to the handle 102 using, for example, any one or more of a press-fit, an adhesive, welding, snap-fits, screws, bolts, rivets, and/or any other suitable form of coupling,

The handle 102 may transition into a flared region 118 such that a width of the handle 102 increases to substantially match a width of the platform 108. As shown, the flared region 118 may include one or more sloped regions 120. The sloped regions 120 may increase the overall strength of the handle 102. Therefore, in some instances, the sloped regions 120 may extend within the handle grip 116 between the first distal end 112 and a second distal end 122 of the handle 102.

As shown, the platform 108 extends from the second distal end 122 of the handle 102, forming an angle θ with the handle 102. The angle θ may be such that an operator of the grill cleaner 100 may use the grill cleaner 100 while, for example, a grill heat source is active without causing bums to the operator. In some instances, the angle θ may be such that, an operator of the grill cleaner 100 may be able to apply sufficient force to the grill cleaner 100 to clean one or more grill grates.

In some instances, the platform 108 may be integrally formed from the handle 102. Therefore, the flared region 118 may transition into the platform 108. In these instances, a bend 124 may be included at the transition point between the flared region 118 and the platform 108 such that the angle θ is formed between the platform 108 and the handle 102. 1n other instances, the platform 108 may be coupled to the handle 102 using, for example, any one or more of a press-fit, an adhesive, welding, a snap-fit, a screw, a bolt, a rivet, and/or any other suitable form of coupling.

As shown, grill scraper 104 extends from the platform 108. The grill scraper 104 may be coupled to (or integrally formed from) the platform 108 such that at least a portion of the grill scraper 104 extends beyond a peripheral edge 126 of the platform 108. As shown, the grill scraper 104 may include a plurality of cutouts. For example, the grill scraper 104 may include a first cutout 128 and a second cutout 130 positioned on opposing ends of the grill scraper 104. The first cutout 128 and the second cutout 130 may have different shapes that each correspond to one or more shapes of the one or more bars defining a respective grill grate. Therefore, the first cutout 128 may include, for example, an arcuate shape, a triangular shape, a pentagonal shape, a trapezoidal shape, an octagonal shape, and/or any other suitable shape. The second cutout 130 may include, for example, an arcuate shape, a triangular shape, a pentagonal shape, a trapezoidal shape, an octagonal shape, and/or any other suitable shape.

The grill scraper 104 may also include one or more additional cutouts 132 capable of receiving at least a portion of a grill grate such that the first or second cutout 128 and 130 are capable of at least partially circumscribing a respective bar forming a grill grate. As such, the first and second cutouts 128 and 130 are capable of engaging (e.g., contacting) both an upper and lower surface of the grill grate at the same time, as will be discussed further herein.

The grill scraper 104 may comprise any material suitable for cleaning a grill grate. For example, the grill scraper 104 may be made of a metal such as a stainless steel alloy or a brass alloy. Regardless, the grill scraper 104 may generally be described as comprising a material that is capable of withstanding the temperatures present in a grill and capable of cleaning a grill grate.

The connecting block 110 may be coupled to the platform 108 such that the wire brush 106 is spaced apart from the platform 108. The connecting block 110 may be coupled to the platform 108 using, for example, any one or more of a press-fit, an adhesive, welding, a snap-fit, a screw, a bolt, a rivet, and/or any other suitable form of coupling. In some instances, the connecting block 110 may reduce the rate of heat transfer from the wire brush 106 to the handle 102. In some instances, the connecting block 110 may be integrally formed from the platform 108. The connecting block 110 may comprise any suitable material including, for example, nylon, polytetrafluoroethylene (PTFE), a silicone rubber, and/or any other suitable material.

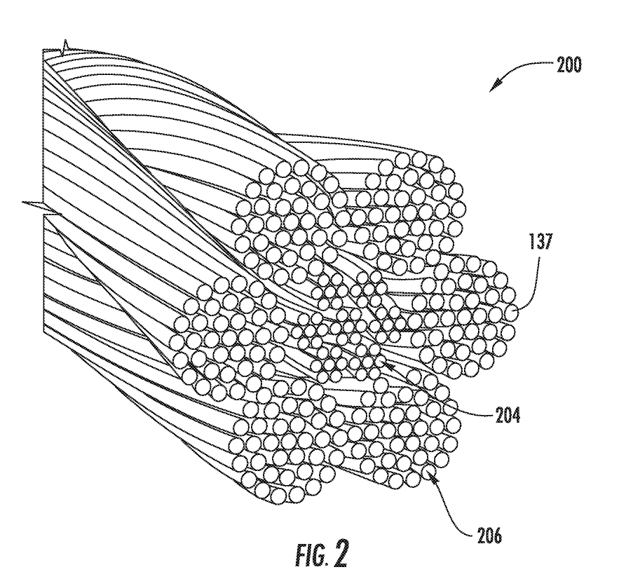

The wire brush 106 may include a brush block 134 having a plurality of wire openings 135 positioned in one or more rows. Each of the wire openings 135 may extend through the brush block 134 such that one or more continuous wires 136 may pass (or extend) through each of the wire openings 135 to form a plurality of wire loops 142. The continuous wires) 136 may include a solid core wire or a wire cable (see FIG. 2) including a plurality of wire strands. As such, the wire(s) 136 may generally be described as being woven through each of the wire openings 135 and the wire brush 106 may generally be described as being a woven wire brush. As shown, the wire(s) 136 are woven to form wire loops 142 having different orientations (e.g., generally orthogonal to each other).

When a continuous wire 136 (solid wire or wire strands) passes through each of the wire openings 135, the overall strength and safety of the wire brush 106 may be increased relative to a wire brush with bristles. For example, a wire brush including a plurality of bristles that extend through only one wire opening may be more susceptible to the bristles separating from the wire brush and becoming lodged within a food product. Consumption of a portion of the bristle may be harmful to a consumer of the food product. By contrast, when a continuous wire 136 passes through each of the wire openings 135, the risk of a portion of the continuous wire 136 separating from the wire brush 106 and becoming lodged in a food product may be reduced. Weaving of a continuous wire (e.g., a single strand or multi-stranded cable/cord) provides strength to prevent breaking. Even if a multi-stranded cord is broken, the broken strands will be held to the cord rather than separating and becoming lodged in food. Similarly, and as will be discussed further herein, having a plurality of continuous wires with both ends coupled to each other (e.g., by crimping) such that each continuous wire forms an individual wire loop may also reduce the risk of at least a portion of the wire forming the wire loop becoming lodged in a food product.

As shown, the continuous wire(s) 136 forms a first set of wire loops 138 on a connecting block facing side 140 of the brush block 134 and a second set of wire loops 142 on a grill facing side 144 of the brush block 134. The connecting block facing side 140 of the brush block 134 may be opposite the grill facing side 144 of the brush block 134. Therefore, the brush block 134 may have a plurality of wire loops on opposing sides of the brush block 134. As shown, a height of the first set of wire loops 138 measures less than a corresponding height of the second set of wire loops 142. The flexibility (or stiffness) of the wire loops 138 may be based, at least in part on, for example, a height of one or more of the wire loops 138, a diameter of one or more of the wires forming the wire loops 138, and/or a material forming the one or more wire loops 138.

The brush block 134 may comprise any suitable material including, for example, nylon, polytetrafluoroethylene (PTFE), a silicone rubber, and/or any other suitable material. The brush block 134 may be coupled to the connecting block 110 using, for example, any one or more of a press-fit, an adhesive, welding, a snap-fit, a screw, a bolt, a rivet, and/or any other suitable form of coupling. In some instances, the brush block 134 may be coupled to the platform 108 using, for example, any one or more of a press-fit, an adhesive, welding, a snap-fit, a screw, a bolt, a rivet, and/or any other suitable form of coupling.

FIG. 2 shows an example of a brush cable 200 that includes a plurality of the wire strands 137. In some instances, the brush cable 200 may have a 0.476 centimeter (cm) ( 3/16 inch) diameter. By incorporating each of the plurality of wire strands 137 into the brush cable 200, the overall durability of the wire brush 106 may be increased. The brush cable 200 may be stronger than an individual wire.

The brush cable 200 may extend through each of the plurality of wire openings 135. The plurality of wire strands 137 forming the brush cable 200 may be formed of any suitable material, for example, a stainless steel alloy, a brass alloy, and/or any other suitable material.

As shown, the plurality' of wire strands 137 of the brush cable 200 may be braided to form a braided wire cable. The plurality of wire strands may form one or more wire bundles. When there are a plurality of wire bundles, the wire bundles may be braided. In some instances, central wire bundles 204 may be of smaller size than exterior wire bundles 206. The plurality of wire strands 137 may be formed of any suitable material, for example, a stainless steel alloy, a brass alloy, and/or any other suitable material/

In operation, one or more of the plurality of wire strands may break, for example, due to wear. However, because each of the plurality of wire strands form the brush cable 200 (e.g., a braided brush cable) the one or more broken wires of the plurality of wire strands may remain coupled to the brush cable 200. As such, the one or more broken wires of the plurality of wire strands 137 may continue to be coupled to the wire brush 106 such that the broken wires do not become lodged in a food product. In other words, a failure of an individual wire strand 137 may not necessarily result in a failure of the brush cable 200. As such, in some instances, the wire brush 106 may continue to be safely used to clean one or more grill grates despite one or more of the plurality of wire strands forming the brush cable 200 being broken.

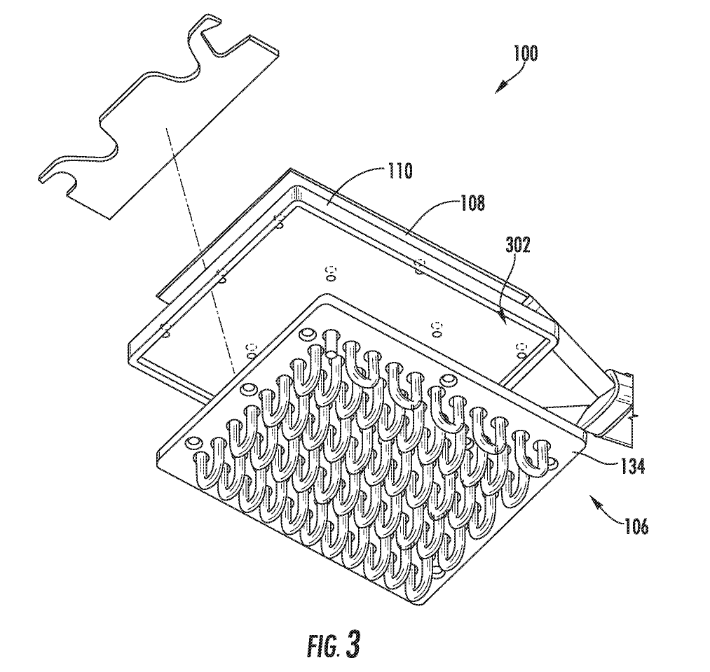

FIG. 3 shows another exploded view of an embodiment of the grill cleaner 100. As shown, the connecting block 110 includes a recessed region 302 for receiving at least a portion of the wire brush 106.

In some instances, the wire brush 106 may be received within the recessed region 302 of the connecting block 110 such that the wire brush 106 is removable replaceable)) by an operator of the grill cleaner 100. For example, at least a portion of the wire brush 106 (e.g., at least a portion of the brush block 134) may form a press-fit or a snap fit with at least a portion of the recessed region 302. In other instances, the wire brush 106 may be coupled to the brush block 134 using, for example, any one or more of an adhesive, welding, a screw, a bolt, a rivet, and/or any other suitable form of coupling.

In some instances, the connecting block 110 may be coupled to the platform 108 such that the connecting block 110 may be removable (e.g., replaceable) by an operator of the grill cleaner 100. For example, replacement of the wire brush 106 may involve decoupling the connecting block 110 from the platform 108. As such, in these instances, the wire brush 106 may not be removably coupled to the connecting block 110.

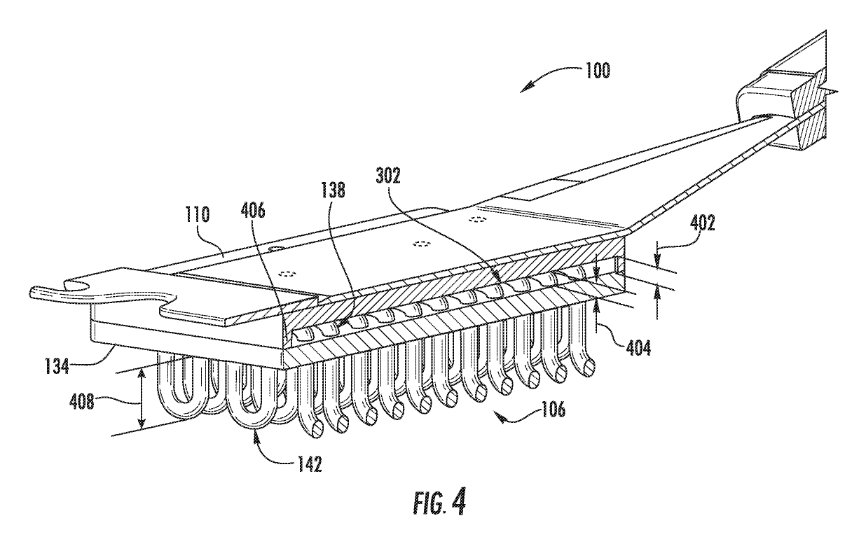

FIG. 4 shows a cross-section of the grill cleaner 100. As shown, the wire brush 106 may be coupled to the connecting block 110 such that the first set of wire loops 138 are received within the recessed region 302. Therefore, a depth 402 of the recessed region 302 may measure substantially equal to a height 404 of the first set of wire loops 138. In other words, the first set of wire loops 138 may generally be described as being positioned between the connecting block 110 and the brush block 134 when the brush block 134 is coupled to the connecting block 110.

As also shown, the brush block 134 may be coupled to a sidewall 406 of the connecting block 110 that defines the recessed region 302. As further shown, a height 408 of the second set of wire loops 142 may measure greater than the height 404 of the first set of wire loops 138.

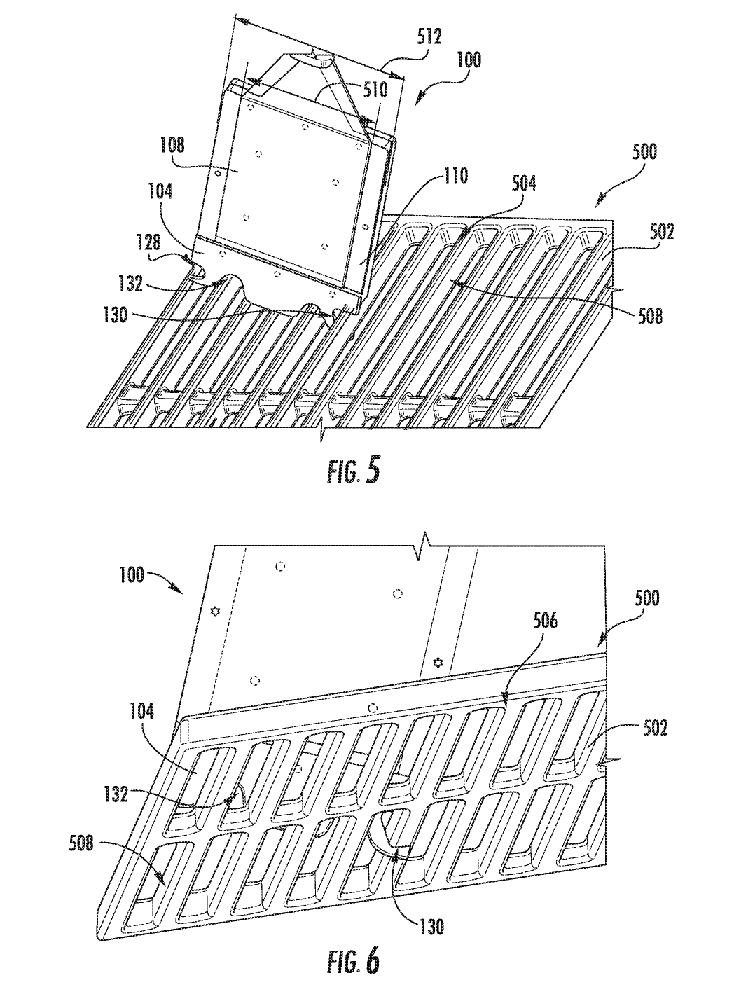

FIGS. 5 and 6 show an embodiment of the grill cleaner 100 cleaning a grill grate 500 having a plurality of trapezoidal shaped bars 502 using the grill scraper 104. As shown, the second cutout 130 has a shape that generally corresponds to the shape of the trapezoidal shaped bars 502. The second cutout 130 engages (e.g., contacts) the trapezoidal shaped bars 502 such that a cooking surface 504 and a heating surface 506 of the trapezoidal shaped bars 502 can simultaneously engage (e.g., contact) the second cutout 130. As a result, the cooking surface 504 and the heating surface 506 can each be simultaneously cleaned. In some instances, the second cutout 130 may also be capable of engaging (e.g., contacting) at least one sidewall 508 of the trapezoidal shaped bars 502 such that the cooking surface 504, the heating surface 506, and the sidewall 508 can be simultaneously cleaned. As also shown, the one or more additional cutouts 132 may extend around adjacent trapezoidal shaped bars 502 such that the second cutout 130 is capable of engaging (e.g., contacting) a respective trapezoidal shaped bar 502. In some instances, the grill scraper 104 may be capable of simultaneously engaging (e.g., contacting) more than one side of a bar forming a respective grill grate 500 such that the scraper 104 substantially cleans more than one side of the bar simultaneously.

Similarly, as shown, the first cutout 128 may be capable of engaging (e.g., contacting) a grill grate having a plurality of cylindrical shaped bars. The first cutout 128 may therefore clean a grill grate having cylindrical shaped bars in a manner similar to that of the second cutout 130, as described herein. As a result, the grill scraper 104 may be generally described as being capable of cleaning multiple grill grates having different shaped bars.

While the grill grates have been generally described as having trapezoidal and cylindrical shaped bars, such a configuration is non-limiting. For example, the grill grates may include bars having one or more of an arcuate shape, a triangular shape, a pentagonal shape, a trapezoidal shape, an octagonal shape, and/or any other suitable shape.

As also shown, a width 510 of the platform 108 may measure less than a width 512 of the connecting block 110.

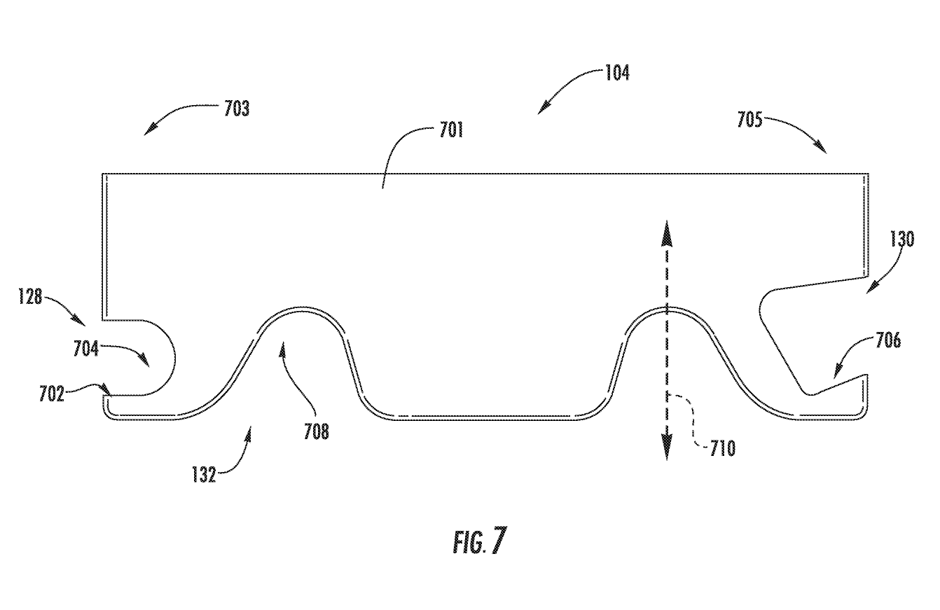

FIG. 7 shows an embodiment of the grill scraper 104 in greater detail. As shown, the grill scraper 104 includes a scraping body 701. The first cutout 128 may be positioned at a first end 703 of the scraping body 701 and the second cutout 130 may be positioned at a second end 705 of the scraping body 701. The first end 703 of the scraping body 701 may be opposite the second end 705 of the scraping body 701. The first cutout 128 may be an arcuate shaped cutout and the second cutout 130 may be a trapezoidal shaped cutout. As shown, the first cutout 128 may include one or more planar regions 702 that transition into an arcuate region 704. The arcuate region 704 is capable of at least partially engaging (e.g., contacting) a corresponding surface of an arcuate shaped bar of a grill grate. As shown, the second cutout 130 includes a plurality of planar regions 706 that collectively define a trapezoidal shape. Each of the planar regions may be capable of at least partially engaging (e.g., contacting) a corresponding surface of a trapezoidal shaped bar of a grill grate. The additional cutouts 132 may be positioned between the first and second ends 703 and 705 of the scraping body 701. In some instances, the additional cutouts 132 may include one or more arcuate shaped regions 708. Therefore, in some instances, the additional cutouts 132 may not be symmetrical about an axis 710 of the additional cutouts 132. Each of the additional cutouts 132 may be sized such that one or more of the first and second cutouts 128 and 130 are capable of engaging (e.g., contacting) a cooking surface (e.g., the cooking surface 504 of FIG. 5) and a heating surface (e.g., the heating surface 506 of FIG. 5) of one or more bars forming a grill grate.

Referring to FIGS. 8-13, a grill cleaner 800, consistent with other embodiments of the present disclosure, is described in greater detail. As shown, the grill cleaner 800 includes one or more handles 802, 814, a grill scraper 804, and a wire brush 806. The wire brush 806 includes a plurality of individual wire loops 808 extending from a brush block 810. In this embodiment, a first handle 802 extends from a side of the wire brush 806 and a second handle 814 is mounted on top of the wire brush 806. The brush block 810 may be coupled to a platform 812 extending from the first handle 802, and the second handle 814 is coupled to or integrally formed from the platform 812 opposite the wire brush 806. The second handle 814 may provide an additional location at which a user may apply a force to the wire brush 806 when cleaning a grate for a grill.

As shown, a grill scraper 804 extends from the platform 812. The grill scraper 804 may include first and second cutouts 801 and 803 on opposing sides of the grill scraper 804. The grill scraper 804 may further include additional cutouts 805. As discussed herein, the cutouts 801, 803, and 805 are configured to engage (e.g., contact) at least one surface of a grill grate, for example, as discussed above.

As shown, the brush block 810 is coupled to the platform 812 using one or more threaded fasteners 816 (e.g., bolts and/or screws). As a result, the brush block 810 may be separable from the platform 812, allowing for the wire brush 806 to be replaced when sufficiently worn. Additionally, or alternatively, the brush block may be coupled to the platform 812 using one or more of a press-fit, an adhesive, welding, snap-fits, screws, bolts, rivets, and/or any other suitable form of coupling.

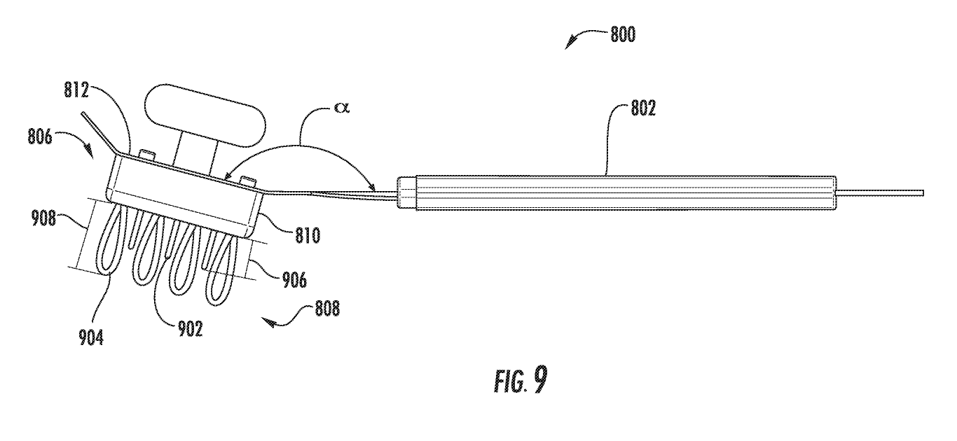

FIG. 9 is a plan view of the grill cleaner 800. As shown, the platform 812 forms an angle α with the first handle 802. The angle α may be selected such that a user may urge the wire brush 806 across a grate for a grill without accidentally touching the grate and potentially burning the user. For example the angle α may be an obtuse angle.

As shown, at least one wire loop of the plurality of wire loops 808 has a height 906 measuring less than a height 908 of at least one other wire loop of the plurality of wire loops 808. Therefore, in sonic instances, the wire loops 808 may generally be described as including at least a first subset of wire loops 902 having the height 906 and a second subset of wire loops 904 having the height 908. By varying the heights 906 and 908, the cleaning properties of the grill cleaner 800 may be improved by having the second plurality of wire loops 904 extend between the bars forming the grate(s) for the grill and having the first plurality of wire loops 902 move across a top surface (e.g., a food facing surface) of the bars forming the grate(s). As each of the wire loops 808 moves across the grate, the wire loops may flex. The flex of the wire loops 808 may be selected to improve the cleaning performance of the grill cleaner 800. For example, the height of the wire loops 808 (e.g., heights 906 and 908) may be chosen based, at least in part, on a desired flex of the wire loops 808. Different subsets of the plurality of wire loops 808 may also have different orientations (i.e., different angles relative to each other and relative to the longitudinal axis of the brush), as described in greater detail below.

As discussed herein, the wire loops 808 may be formed of a solid core wire and/or a cable/cord having a plurality of wire strands. For example, the wire loops 808 may be formed using a 303 or 18-8 stainless steel cable having a diameter of approximately 2.38 millimeters (mm) ( 3/32 inch) coupled to the brush block 810. By way of further example, in some instances, the wire loops 808 may be formed of a lubricated 18-8 stainless steel cable. However, the wire loops 808 are not limited to being formed of 303 or 18-8 stainless steel. For example, the wire loops 808 may be formed of a brass alloy, other stainless steel alloys, and/or any other suitable material. In some instances, at least a portion of the wire loops 808 (e.g., the first plurality of wire loops 902) may be formed of a first material and at least a portion of the wire loops (e.g., the second plurality of wire loops 904) may be formed of a second material that is different from the first.

FIG. 10 is an exploded view of the brush block 810. As shown, each of the wire loops 808 are formed by coupling and securing opposing ends of a wire into a sleeve 1002 (e.g., a compression sleeve or a crimp connector). Once both ends of the wire are received within the sleeve 1002, the sleeve 1002 can be compressed (e.g., crimped) such that the sleeve 1002 forms a press fit with the wire (or cable), forming a respective wire loop 808. In some instances, the sleeve 1002 may be coupled to the opposing ends of the wire forming a respective wire loop 808 using, for example, an adhesive, insert molding, and/or any other suitable form of coupling. Therefore, the sleeve 1002 may be made of a brass alloy, a stainless steel alloy, an aluminum alloy, a copper alloy, nylon, polytetrafluoroethylene (PTFE), a silicone rubber, and/or any other suitable material. The individual wire loops 808 in this embodiment are easier to manufacture with less waste.

The brush block 810 includes a plurality of receptacles (or sockets) 1004 configured to receive a respective sleeve 1002. At least one of the plurality of receptacles 1004 may be oriented relative to a block axis 1006 such that a receptacle axis 1014 extends transverse to the block axis 1006. Therefore, at least one of the wire loops 808 may have a loop axis 1005 that extends transverse to the block axis 1006, wherein the loop axis 1005 extends through and perpendicular to the at least one wire loop 808. As shown, the block axis 1006 extends from a distal end 1018 of the brush block 810 to a proximal end 1020 of the brush block 810, wherein the proximal end 1020 is adjacent the handle 802 (see FIG. 8). Therefore, in some instances, the block axis 1006 may generally be described as a longitudinal axis of the brush block 810. In some instances, the block axis 1006 may be generally described as a central axis of the brush block 810 that extends from the distal end 1018 to the proximal end 1020 of the brush block 810. As also shown, the receptacle axis 1014 extends through a respective receptacle 1004 such that, when a sleeve 1002 including a wire (or cable) forming the wire loop 808 is received within the respective receptacle 1004, the receptacle axis 1014 intersects both ends of the wire (or cable) forming the wire loop 808. Therefore, in some instances, the receptacle axis 1014 may generally be described as being a longitudinal axis of a respective receptacle 1004.

As shown, the receptacles 1004 may include a first group of receptacles 1008, a second group of receptacles 1010, and a third group of receptacles 1012. The first group of receptacles 1008 and the second group of receptacles 1010 are disposed on opposing sides of the block axis 1006 and are configured to receive a respective sleeve 1002 corresponding to a respective one of the wire loops of the second plurality of wire loops 904. The third group of receptacles 1012 may be disposed along the block axis 1006 such that at least a portion of the third group of receptacles 1012 is disposed between the first and second groups of receptacles 1008 and 1010. As shown, the third group of receptacles 1012 is configured to receive a respective sleeve 1002 corresponding to a respective one of the wire loops of the first plurality of wire loops 902. The first and second groups of receptacles 1008 and 1010 may be oriented relative to the block axis 1006 such that the receptacle axis 1014 of the receptacles 1004 extends traverse to the block axis 1006.

As shown, each receptacle in the third group of receptacles 1012 includes at least one cutout 1016 for receiving at least a portion of the wire (or cable) forming a respective wire loop 808 in the first plurality of wire loops 902. As a result, at least a portion of the wire loop 808 may be supported by the cutout 1016, which may decrease the flexibility of the wire loops 808 in the first plurality of wire loops 902 when compared to the second plurality of wire loops 904. Additionally, or alternatively, the flexibility of the wire loops 902 may be based, at least in part on, a height of one or more of the wire loops 902, a diameter of one or more of the wires forming the wire loops 902, and/or a material forming the one or more wire loops 902.

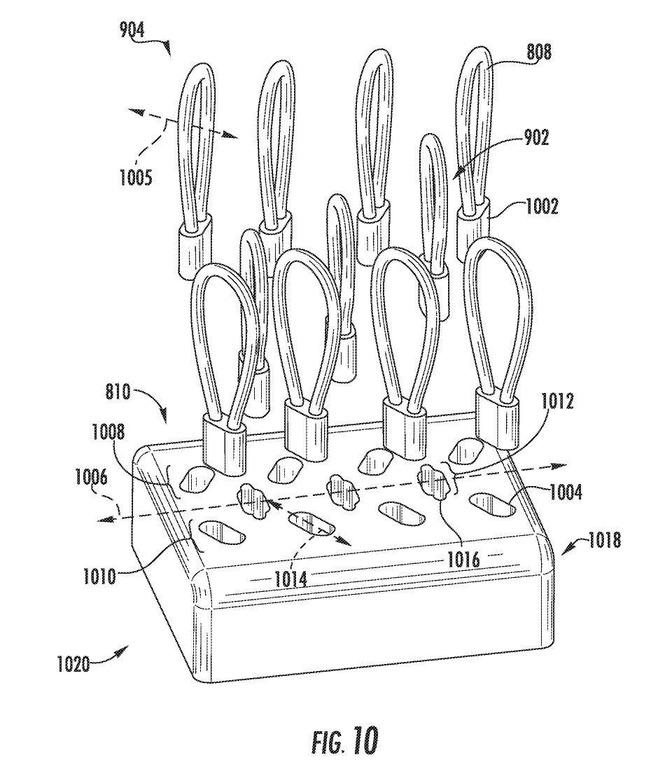

FIG. 11 shows a cross-sectional view of the brush block 810. As shown, at least a portion of the first plurality of wire loops 902 is received within the third group of receptacles 1012 such that a top surface 1104 of the sleeve 1002 is recessed relative to a top surface 1102 of the brush block 810. By positioning at least a portion of the first plurality of wire loops 902 within the third group of receptacles 1012, the flexibility of the first plurality of wire loops 902, relative to the second plurality of wire loops 904, may be decreased. As shown, the top surface 1104 of the sleeves 1002 corresponding to the second plurality of wire loops 904 may be substantially (e.g., within manufacturing tolerances) co-planar with the top surface 1102 of the brush block 810.

Once received within a respective receptacle, the sleeve 1002 may be coupled to the brush block 810 using one or more of a press-fit, an adhesive, welding, snap-fits, screws, bolts, rivets, and/or any other suitable form of coupling. The brush block 810 may be formed of, for example, a nylon (e.g., nylon 6/10), polytetrafluoroethylene (PTFE), a silicone rubber, and/or any other suitable material.

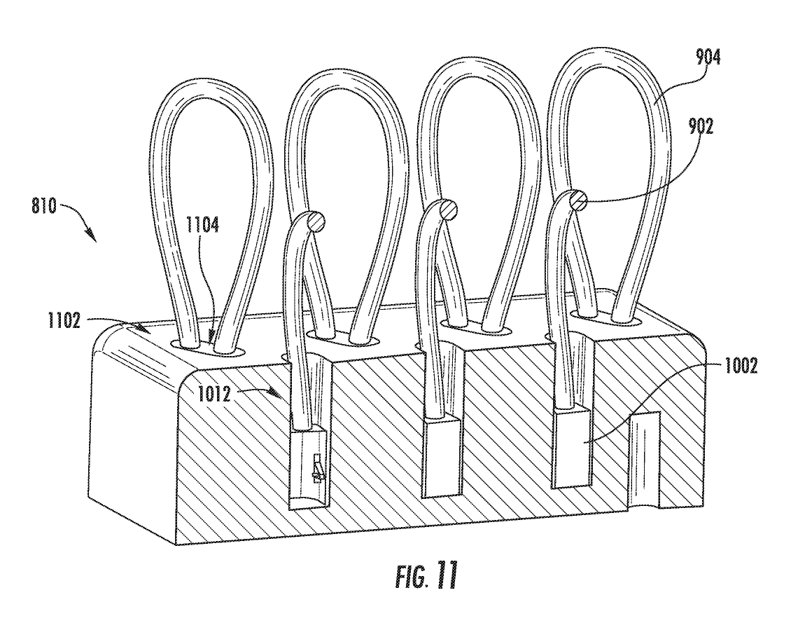

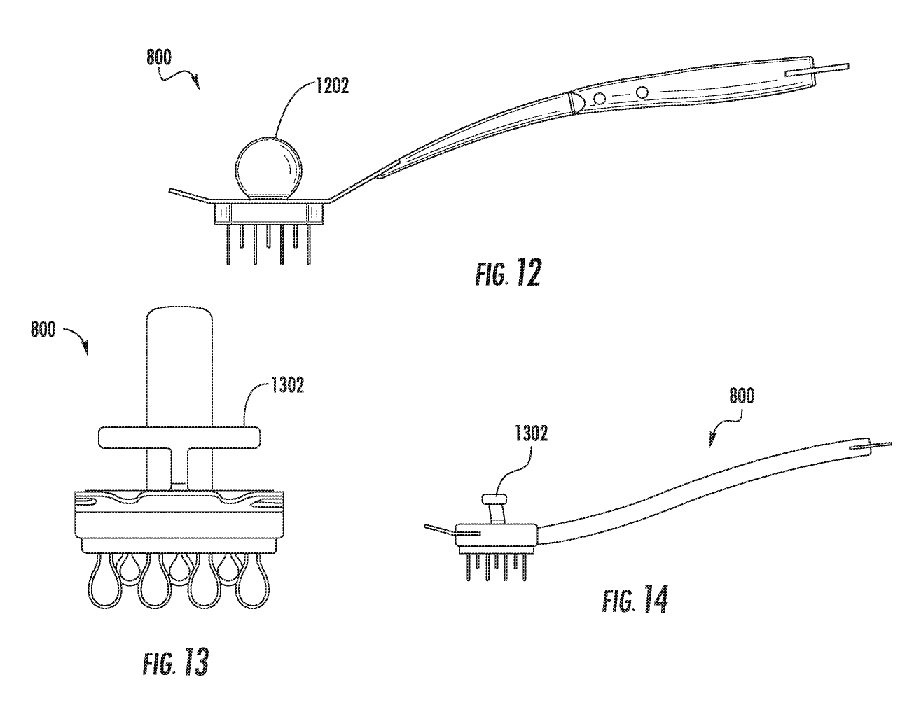

FIG. 12 shows an example of a second handle 1202 having a generally spherical or ball-shape (e.g., a knob) that may generally correspond to a shape/size of a user's hand. FIGS. 13 and 14 show an example of the second handle 1302 having a T-shape. The second handle 1302 may be oriented (and/or angled) to improve a user's ability to apply a force to the grill cleaner 800. The second handles 1202 and 1302 may be textured such that a user may more easily grasp the second handles 1202 and 1302. In some instances, the second handles 1202 and 1302 may made of two or more materials. For example, the second handles 1202 and 1302 may include both a wood (e.g., oak, maple, pine, and/or the like) and a metal (e.g., an aluminum alloy, a steel alloy, a copper alloy, a brass alloy, and/or the like). In some instances, the second handles 1202 and 1302 may be made of a single material (e.g., nylon, a brass alloy, a stainless steel alloy, an aluminum alloy, a copper alloy, a wood, and/or the like). While the second handles 1202 and 1302 are generally shown as having a ball-shape or T-shape, such configurations are non-limiting. The second handles 1202 and 1302 may have any suitable shape including, for example, a puck-shape (e.g., as shown in FIG. 8).

According to one aspect of the present disclosure, a grill cleaner is provided for removing debris from a grate of a grill. The grill cleaner includes a wire brush including a brush block and a plurality of wire loops extending from the brush block, at least one handle coupled to the wire brush, and a scraper coupled to the wire brush.

According to another aspect of the present disclosure, a grill cleaner is provided for removing debris from a grate of a grill. The grill cleaner includes a wire brush including a brush block and a plurality of individual wire loops extending from the brush block. Each wire loop of the plurality of individual wire loops includes a sleeve securing ends of the wire loop. The grill cleaner also includes at least one handle coupled to the wire brush.

According to yet another aspect of the present disclosure, a wire brush is provided for a grill cleaner. The wire brush includes a brush block having a plurality of receptacles. The longitudinal axis of at least one receptacle extends transverse to a longitudinal axis of the brush block. The wire brush also includes a plurality of individual wire loops extending from the brush block. Each individual wire loop of the plurality of individual wire loops includes a sleeve securing ends of the wire loop, wherein the receptacles in the brush block are configured to receive the sleeves, respectively.

While particular embodiments of the present disclosure have been illustrated and described, it would be obvious to those skilled in the art that various other changes and modifications can be made without departing from the spirit and scope of the disclosure. It is therefore intended to cover in the appended claims all such changes and modifications that are within the scope of this disclosure.

What is claimed is:

1. A grill cleaner for removing debris from a grate of a grill, comprising:
a wire brush including a brush block and a plurality of wire loops extending from the brush block; and
at least one handle coupled to the wire brush.

2. The grill cleaner of claim 1, wherein the plurality of wire loops are formed as individual wire loops and each individual wire loop of the plurality of wire loops includes a sleeve securing ends of the individual wire loop.

3. The grill cleaner of claim 2, wherein the sleeve is a crimp connector.

4. The grill cleaner of claim 2, wherein the brush block further comprises a plurality of receptacles configured to receive the sleeves, respectively,

5. The grill cleaner of claim 1, wherein at least one subset of wire loops has a different orientation than at least one other subset of wire loops.

6. The grill cleaner of claim 1, wherein at least one subset of wire loops has a different height than at least one other subset of wire loops.

7. The grill cleaner of claim 1, wherein the at least one handle includes a first handle extending from a side of the wire brush.

8. The grill cleaner of claim 7, wherein the at least one handle includes a second handle mounted on a top of the wire brush.

9. The grill cleaner of claim 8, further comprising a platform mounted to the brush block, wherein the first handle extends from a side of the platform and the second handle is mounted to a top of the platform.

10. The grill cleaner of claim 1, further comprising a scraper coupled to the wire brush.

11. The grill cleaner of claim 10, wherein the scraper includes a first cutout and a second cutout, the first and second cutouts being disposed on opposing ends of the scraper.

12. The grill cleaner of claim 1, wherein the plurality of wire loops are formed by at least one continuous wire extending through the brush block.

13. A grill cleaner for removing debris from a grate of a grill, comprising:
a wire brush including a brush block and a plurality of individual wire loops extending from the brush block, wherein each wire loop of the plurality of individual wire loops includes a sleeve securing ends of the wire loop; and
at least one handle coupled to the wire brush.

14. The grill cleaner of claim 13, wherein the sleeve is a crimp connector.

15. The grill cleaner of claim 13, wherein the brush block further comprises a plurality of receptacles configured to receive the sleeves, respectively.

16. The grill cleaner of claim 13, wherein at least one subset of wire loops has a different orientation than at least one other subset of wire loops.

17. The grill cleaner of claim 13, wherein the plurality of wire loops include a first row of wire loops arranged at a first angle relative to a longitudinal axis of the wire brush and at least a second row of wire loops arranged at a second angle relative to the longitudinal axis of the wire brush.

18. The grill cleaner of claim 13, wherein at least one subset of wire loops has a different height than at least one other subset of wire loops.

19. The grill cleaner of claim 13, wherein the scraper includes a first cutout and a second cutout, the first and second cutouts being disposed on opposing ends of the scraper.

20. A wire brush for a grill cleaner, comprising:
a brush block having a plurality of receptacles, wherein a longitudinal axis of at least one receptacle extends transverse to a longitudinal axis of the brush block; and
a plurality of individual wire loops extending from the brush block, each individual wire loop of the plurality of individual wire loops including a sleeve securing ends of the wire loop, wherein the receptacles in the brush block are configured to receive the sleeves, respectively.

21. The wire brush of claim 20, wherein at least one subset of wire loops has a different orientation than at least one other subset of wire loops.

22. The wire brush of claim 20, wherein the wire loops are formed of a wire cable.

23. The wire brush of claim 20, wherein the wire loops include an arcuate portion.
